(19) United States
(12) Patent Application Publication
(10) Pub. No.: US 2025/0245788 A1
(43) Pub. Date: Jul. 31, 2025

(54) METHOD FOR GENERATING AN OVERLAY IMAGE AND ASSOCIATED IMAGE RECORDING DEVICE

(71) Applicant: Soholly Fiberoptic GmbH, Denzlingen (DE)

(72) Inventors: Sebastien Weitbruch, Niedereschach (DE); Andreas Hille, Villingen-Schwenningen (DE); Pranita Bisht, Villingen-Schwenningen (DE)

(73) Assignee: Scholly Fiberoptic GmbH, Denzlingen (DE)

(21) Appl. No.: 19/036,334

(22) Filed: Jan. 24, 2025

(30) Foreign Application Priority Data
Jan. 25, 2024 (DE) 102024102099.7

(51) Int. Cl. G06T 5/50; G06V 10/56; G06V 10/60; H04N 1/60

(52) U.S. Cl. CPC G06T 5/50; G06V 10/56; G06V 10/60; H04N 1/60; G06T 2207/20221

(57) ABSTRACT

To generate realistic overlay images (1) which are true-color with respect to at least one false color FF(x,y) used to visualize a spectral image (3a, 3b), a method and an associated image recording device (5) are provided, which enable undesired color shifts of such a false color to be avoided in the overlay image and a high image brightness of a white light image illustrated as an image background and the original image contrast of the white light image to be substantially maintained in the overlay image in spite of the overlay. Here, at least one color channel value of the white light image, which is complementary to the respective false color to be locally displayed, is locally deliberately reduced in each case, so the higher the resulting intensity I(x,y) of the spectral image (3a) also to be visualized in the overlay image is at this point (x,y).

### CROSS-REFERENCE TO RELATED APPLICATIONS

This application claims priority from German Patent Application No. 10 2024 102 099.7, filed Jan. 25, 2024, which is incorporated herein by reference as if fully set forth.

### TECHNICAL FIELD

The invention relates to a method for generating an overlay image, wherein the overlay image jointly visualizes image signal components of a white light image (WLI) and image signal components of a spectral image. The spectral image can in particular be provided in this case in the form of a fluorescence image, which thus visualizes a fluorescent light. In this approach, local intensity values I(x,y) of the spectral image/fluorescence image are visualized in at least one local false color FF(x,y) in the overlay image.

Thus, in particular multiple different false colors can be used for visualizing the spectral image in the overlay image, wherein then the respective false color permits an inference about the underlying intensity of the original spectral image. In contrast, if only a single false color is used, for example, the saturation or the brightness of this false color can enable an inference about the intensity values I(x,y) of the spectral image.

The white light image, which is also to be at least partially visualized in the overlay image, can be visualized, for example, by means of grayscales or by means of true colors in the overlay image. Furthermore, it can be provided that to generate the overlay image, local color channel values of the white light image (thus, for example, R/G/B values if three color channels red/green/blue are used) and associated local signal values of the spectral image are offset with one another. The spectral image can be provided in this case, for example, as a grayscale image, so that then the signal values are grayscales (GW). Or the spectral image is already provided, for example, in a false color representation, wherein then the local signal values can be, for example, R/G/B values, namely if the spectral image is provided in the false color representation as an RGB image.

The invention furthermore relates to an image recording device, which can preferably be designed in the form/as a part of a medical visualization system. This system can comprise, for example, an endoscope, an exoscope or a microscope as the respective image recording device. Furthermore, the visualization system can also comprise further components, such as a camera control unit and a display device. The image recording device or this visualization system comprises at least one image sensor, in particular at least two image sensors, which is/are configured for sensorially capturing a white light image and/or a spectral image (in particular for sensorially capturing a fluorescence image). Furthermore, the device/the system comprises an image signal processing unit or processor, which is configured to calculate an overlay image (in particular as explained above) from a white light image and a spectral image, which images are/were each recorded using the at least one image sensor. The device/the system can output the overlay image here, for example, in the form of a digital overlay image and/or display it on the display device.

### BACKGROUND

Different types of fluorescence imaging are already previously known in the prior art, in each of which a white light image is sensorially captured separately from a fluorescence image. In addition, there are also still further imaging approaches, in which, in addition to a white light image, such a spectral image is sensorially captured separately, which then only visualizes a specific portion of a spectrum used for imaging. In such approaches, an image generating chain is thus established by signaling, which generates a white light image and a spectral image separately therefrom. In this case, the white light image visualizes broadband wavelengths in the visible wavelength range, while the spectral image visualizes a narrower spectral range in comparison thereto, for example, in the near infrared (NIR). If a fluorophore having an excitation wavelength in UV is used, for example, which fluorophore emits a fluorescence wavelength in NIR, on the one hand, a white light image can thus be sensorially captured, for example, using a typical color image sensor and employing a broadband illumination and furthermore the NIR fluorescence wavelength can be sensorially captured as a spectral image/fluorescence image using an additional monochromatic sensor spatially separate therefrom. The fluorescence image visualizes an intensity distribution I (x, y) of a fluorescence signal sensorially captured using the monochromatic sensor in such a case, which can be, for example, in a wavelength range of less than 100 nm bandwidth, wherein then the monochromatic fluorescence image is typically initially recorded as a grayscale image.

In addition, visualizing such a spectral image by means of a false color representation is already known. For this purpose, a so-called mapping function is typically used, which assigns a specific false color to each intensity value I(x,y) or the grayscale GW of the spectral image resulting therefrom, so that a colored false color spectral image can be obtained. It is even possible in this case to use only a single false color, wherein then the brightness and/or the saturation of this false color is varied to visualize the different intensity levels in the spectral image.

In many applications, it is now advantageous if the white light image and the spectral image are visualized to the user in the form of an overlay image. Specifically, one advantage of this approach is that the spatial impression of the recorded scene can thus be visualized with the aid of the (ideally colored) white light image and that at the same time, for example, a fluorescence signal can be made visible in the overlay image by means of at least one false color of the spectral image.

There are also already approaches for using a mapping function, which maps the different intensity values of the fluorescence signal visualized in the fluorescence image on a predefined scale of different false colors. In this case, the fluorescence signal can be visualized by means of multiple false colors according to a previously defined false color scale, for example in the form of a so-called “heat map”.

In particular in medical applications, there is often the problem that individual image areas, in particular where surfaces are damp and therefore display a high reflectivity, exceed the maximum displayable brightness range. As a result, these image areas are visualized in white color in the white light image, but the actual color information is fundamentally lost, specifically because the white color indicates that all color channels used of the image sensor employed display maximum intensity values, a phenomenon which is known under the name “clipping”. Such original clipping does not always have to be disturbing, however, but rather it can even improve the spatial impression of the white light image. “Clipping” is thus understood in image signal processing as exceeding a permissible signal range, which is thus displayable in the image, for example due to an overload, thus an overshoot of the respective signal. With respect to a white light image, this can be understood as a pixel or a larger image area in which all color channels used display a signal full scale, thus the respective maximum possible signal value.

If the white light image and the fluorescence image are now overlaid by simple addition of the signals, it can occur that individual image areas of the overlay image, in which previously original clipping was not yet observed, only now display additional clipping. Such additional clipping is very disadvantageous, however, because then the operator who observes the overlay image can no longer draw a reliable inference in these image areas about the existing intensity of the fluorescence signal, which is in particular supposed to be visualized by means of a false color. It would therefore be desirable, on the one hand, to maintain the original clipping under certain circumstances, in particular in image areas which do not display a significant fluorescence signal, but, on the other hand, to avoid as much as possible additional clipping in the overlay image, which only results due to the overlay of the two images, so that the fluorescence image is visualized with the correct false color in the overlay image.

A further technical problem to be solved in overlay images is that in particular upon the overlay of a colored white light image with a spectral image/fluorescence image represented in at least one false color, an undesired color shift of the respective false color to be represented in each case can occur, in particular in those image areas in which, for example, a relevant fluorescence signal was sensorially captured, which is accordingly to be highlighted using a false color in the overlay image. Such a color shift is problematic in the application, because the user is to infer the sensorially captured intensity of the fluorescence signal on the basis of the false color. Therefore, a color shift can result in an incorrect interpretation of the intensity of the fluorescence signal and is therefore at least to be limited or entirely avoided. This is necessary in particular in medical applications, because otherwise an incorrect diagnosis can occur on the basis of a false color which is not correctly visualized.

There are also already approaches in the prior art to avoid “additional clipping” as described above in an overlay image as well as a color shift possibly occurring therein, namely so-called “alpha blending”: The approach of this method is to provide the respective image data, thus, for example, the RGB values of the respective pixel of the white light image and the spectral image, globally (thus for the entire image) in each case with a respective weighting and to select this weighting here in particular so that additional clipping is just avoided in the generated overlay image. In general, a global transparency value is thus used in “alpha blending”. The brightness of the WLI channel will therefore also be reduced if no single at all is present in the spectral image.

However, using such alpha blending, it is possible that in each color channel, the respective signal value of the overlay image remains within an available/displayable value range. If, for example, the entire white light image is weighted with a factor α₁, the spectral image can be added after weighting with the factor α₂=1−α₁, in order to thus obtain an overlay image. This approach does avoid additional clipping, but has the decisive advantage that due to the global weighting, image brightness is also lost in image areas in which this would not necessarily be required. In other words, overlay images generated using this method often display inadequate brightness of the white light background.

Moreover, it is generally desirable in the generation of overlay images to avoid contrast losses as much as possible and also a loss of color saturation of the spectral image, thus in particular a loss of color saturation of the false colors, in which the spectral image is visualized in the overlay image.

### SUMMARY

Proceeding from this background, the invention is based on the object of proposing an improved method, which solves the problem stated above and can supply true-color overlay images having a high color saturation and high contrast. In addition, the invention is also to provide an associated image recording device, using which such high-quality overlay images, in particular for medical applications, can be reliably generated.

According to the invention, one or more of the features disclosed herein are provided to solve the mentioned object. In particular, it is therefore proposed according to the invention that to achieve the object in a method as described at the outset, at least one complementary color channel value of the white light image is reduced locally and selectively in relation to the remaining local color channel values of the white light image. This reduction does not take place globally here (as in alpha blending), but rather in direct or at least in indirect dependence on an associated local intensity value I (x, y) of the spectral image. The complementary color channel value is complementary here to at least one local false color, in which (as mentioned at the outset) the local intensity values I(x,y) of the spectral image/fluorescence image are (supposed to be) visualized.

In other words, as mentioned at the outset, the spectral image is thus visualized in the overlay image by means of at least one local false color, wherein locally means here that this at least one false color, depending on the local intensity value I(x,y) of the original spectral image, can vary over the overlay image: For example, the color value (hue) of the false color can change or, for example, if only a single green false color is used, its saturation value or brightness value can change. For a specific point (x,y) within the overlay image and the false color FF(x,y) to be visualized there, a complementary color can be determined at any time, which is complementary to this local false color. Accordingly, however, the complementary color and therefore the complementary color channel value of the white light image can also change over the overlay image: If a blue false color is to be visualized at a first point, the red and the green color channel of the white light image are complementary thereto at this point. In contrast, if a yellow false color is to be visualized at a second point, the blue color channel of the white light image is complementary at this second point. Accordingly, according to the method according to the invention, red and green color channel values (R and G values) of the white light image are then reduced at the first point and the blue color channel value (B value) is reduced at the second point.

It can thus be determined in each case (depending on location) which of the color channels (three color channels R, G, B are typical here) used to represent the white light image is complementary to the local false color. And then the color channel value of this complementary color channel can accordingly be reduced locally, thus at the point of said local false color.

The technical effect which is achieved by the selective location-dependent reduction is initially that the white light image is somewhat distorted in its color authenticity. However, upon the superposition of the white light image with the spectral image in the overlay image, in this way only those color components of the white light image are accentuated which correspond to the local false color to be displayed locally according to the spectral image. The colors of the white light image complementary thereto, thus more precisely the color channel value of the associated at least one complementary color channel of the white light image, in contrast, is attenuated by said reduction, which in particular prevents a significant color shift of the local false color to be displayed from occurring in the overlay image upon said overlay. In other words, it is thus ensured in this manner that the false colors in the overlay image are visualized in true color, thus without significant color shift. A more reliable inference on the basis of the visualized false color of the underlying intensity of the original spectral image is thus possible for the user, which, among other things, enables more accurate diagnoses in medical applications.

In said method, it is preferred here if the remaining/residual color channel values (thus, for example, R and G, if B is the complementary color channel value) of the white light image are locally and selectively maintained or even increased in direct or indirect dependence on the local intensity value I (x, y) of the spectral image. Due to such a targeted local increase of the remaining color channel values, with simultaneous reduction of the complementary color channel value, the image brightness can be at least approximately maintained locally in each case. The contrast ratios of the white light image can thus be retained better and therefore a more realistic overlay image can be obtained.

It is furthermore preferred in the method if the at least one complementary color channel value of the white light image is reduced more strongly depending on location the higher the resulting respective local intensity value I(x,y) of the spectral image is. It is also again true here that this reduction does not necessarily have to take place in direct dependence on the local intensity value I(x,y), but rather, as will become even more clear, for example, also on the basis of a false color, which is in turn dependent on the local intensity value I(x,y) (this would then be an indirect dependence on I(x,y)). For example, false color values of a false color representation of the spectral image can also be used as input variables in order to determine which color channel value of the white light image at a specific point (x,y) of the overlay image is complementary to the local false color to be visualized at this point. It is to be taken into consideration for this purpose that in image areas in which the spectral image has no appreciable intensity, there is a lower risk of color deviations, so that the complementary color channel value of the white light image only has to be reduced very little or even not at all there. However, this is advantageous in particular to retain the color authenticity of these image areas of the white light image in the overlay image. For this purpose, an image area can be imagined in which the spectral image displays an intensity value of zero: The white light image does not have to be adjusted at all there, i.e. no reduction of the complementary color channel value also has to take place there, so that the white light image can be visualized in the overlay image without any color change in these image areas.

In summary, it can thus be stated that the at least one complementary color channel of the white light image can be reduced by different strengths, in particular not at all, at different locations/points (x,y) of the overlay image, namely depending on the associated local intensity value I(x,y) of the spectral image.

It is also to be mentioned at this point that the method according to the invention can obviously also be used to generate a progressive video image data stream of live overlay images, proceeding from a first stream of live white light images and a second stream of live spectral images. In this case, the intensity I(x,y) of the spectral image can change with time and accordingly which color channel value of the white light image is reduced how strongly at which points will then also change in each case from image to image. This is not comparable with alpha blending varying over time, because in alpha blending a weighting is only changed globally, but not in a location-resolved manner in at least indirect dependence on a local I(x,y) of the spectral image.

It is furthermore also to be noted that, for example, color channel values (R,G,B) of a false color representation of the spectral image can also be used as input variables in the method in order to determine which color channel/color channel value of the white light image at a specific point (x, y) of the white light image is complementary to the local false color. In other words, the reduction of the complementary color channel value can thus be performed in direct dependence on color channel values of a false color spectral image which is to be visualized in the overlay image. However, there is also an at least indirect dependence in this case on the associated local intensity I(x,y) of the spectral image, namely because in particular the false colors of the false color spectral image are a function of the respective local intensity value I(x,y) of the original spectral image, thus depend directly on these intensity values.

The term “local” can be understood here in particular to mean that the described local manipulation of the respective color channel value of the white light image is completed at a specific point (x,y) within the overlay image, and specifically as a function of a corresponding intensity value I(x,y) at the same point in the spectral image/fluorescence image. It is obvious that the white light image and the spectral image are to have the same size for this purpose upon the desired overlay. If this is originally not the case, for example, due to different spatial resolution of the images, an equal image size can be achieved by corresponding scaling of at least one of the two images.

Using the method according to the invention, for example, it is possible to achieve that at those points (x,y) of the white light image (2) at which high intensity values I(x,y) were sensorially captured in the corresponding spectral image (3a), the local color channel values (R/G/B) of the white light image (2) associated with these points are adjusted so that the color channel values (R/G/B) of the white light image (2), which do not correspond to the associated local signal values (R/G/B) of the false color representation FF(x,y) of the spectral image at these points (x,y), are thus complementary to the respective false color, are reduced. It is thus effectively possible to prevent a relevant color shift (color drift) with respect to the false color to be displayed in the overlay image thus generated from occurring upon the overlay of the white light image with the false color representation of the spectral image.

The essential technical advantage of the method according to the invention is thus that a desired false color representation of the spectral image, which can be linked, for example, with an intensity false color scale, is retained. It is to be taken into consideration in this case that an overlay/superposition of identical or similar color components does not result in a relevant “color drift”, but rather only the overlay of a false color with its respective complementary color. Because the method deliberately locally suppresses these complementary colors in the relevant image areas, however (namely where relevant intensity I(x,y) is observed in the spectral image) (due to the deliberate location-resolved/local reduction of the complementary color channel values (for example, “B value” in the case of yellow false color) of the white light image as a function of the corresponding intensity I(x,y) of the spectral image), a “color drift” in the overlay image with respect to the respective false color to be displayed is very effectively avoided. This approach is similarly applicable here if only a single false color (for example, in different saturation and/or brightness) is used for visualizing the intensity of the spectral image (for example, light to dark green) or if multiple false colors (for example, a continuous false color scale from black via dark blue, turquoise, green, to yellow) are used and the intensity I(x,y) of the spectral image is therefore visualized, in particular exclusively, via a change of the color value (hue) of the false color.

The HSV color space (H=hue=color value; S=saturation=color saturation; V=value=brightness) is observed as an example for this purpose: The false color representation can only change, for example, the brightness V for a specific H value; or brightness and saturation are kept constant and the hue value is varied as a function of the intensity I(x,y) (=traveling along a circular arc line in the HSV space).

In both cases, a very realistic and bright overlay image can thus be obtained as a result, the white light components of which can be reproduced practically unadulterated in the regions of lower intensity I(x,y) of the spectral image (because no significant adjustment of the image signal components of the white light image is performed there), while the false color representation of the intensity distribution of the original spectral image is true-color in the overlay image in the meaning that a user can still, on the basis of the visualized false color and/or its saturation and/or its brightness, reliably and accurately infer the original intensity I(x,y) in the spectral image. In particular for users who use the method in medical imaging, the image perception is thus significantly improved and a more accurate interpretation of the overlay image is enabled. This can result, for example, in improved diagnostics.

Considered from a somewhat different viewpoint, the approach according to the invention can also be described as follows:

To achieve the object it can be provided, in particular additionally to the above-explained method features and/or additionally to the method with one or more of the features described herein, that the overlay image jointly visualizes image signal components of a white light image and image signal components of a spectral image, in particular of a fluorescence image. To achieve the object, it can furthermore be provided that to generate the overlay image, a respective ratio, using which respective local color channel values (for example, R/G/B) of the white light image and associated respective local signal values (for example, R/G/B or GB) of the spectral image are offset with one another, is selected depending on location and in direct or indirect dependence on the respective original local intensity value I (x, y) of a respective pixel (x, y) of the spectral image. This ratio, which can be understood as a type of local weighting between white light image and spectral image, can thus preferably be selected/changed pixel by pixel, and in particular as described above in director at least indirect dependence on the local intensity value of the spectral image.

Using this approach, a respective weighting between the local color channel values of the white light image and the local signal values of the spectral image can thus change in a location-dependent manner in the overlay image, namely depending on the local original intensity value I (x, y) of the spectral image. This change can be selected here pixel by pixel or individually in each case at least for specific image areas/can change pixel by pixel or image area by image area.

According to the invention (in contrast to global alpha blending), a suitable weighting between the image signal components of the white light image and the image signal components of the spectral image/fluorescence image at a specific time in the overlay image can accordingly come to bear. In the method approach according to the invention, depending on the instantaneous intensity distribution I(x,y) of the currently captured spectral image, this local weighting can change here, so that the distribution of the weighting can also change across the overlay image from image recording time to image recording time. The method according to the invention thus permits a chronologically and spatially dynamic adaptation of the overlay process, for example, during the generation of a video image data stream (consisting of progressively newly calculated overlay images, which are based on a respective first video stream of white light images and a second video stream of spectral images). The dynamic arises here due to the chronological and/or spatial change of the intensity I(x,y) of the spectral image, because this influences the respective local weighting which is locally applied upon overlaying the two images.

The original spectral image can have respective signal values/pixel values here, which correspond to a respective sensorially captured intensity I(x,y) of a spectral light signal, in particular a fluorescence signal. As an intermediate step, however, a false color representation of the spectral image (false color image=FCI) can also be generated in a way known per se. If a “heat map” is used as the mapping function for this purpose, which thus maps a respective intensity I(x,y) in a space of false colors (this false color partial space can cover only a single color value or, for example, a continuous range of color values/hue values, as explained above on the basis of the HSV color space), this false color image (FCI) can thus also have different false color signal values, thus in particular different false colors/color values/hue values. The signal values of the spectral image can thus fundamentally be present as intensity values I(x,y) or after corresponding image processing can already be present as false color signal values (for example, as R/G/B values).

Color channel values of the white light image (WLI) can be, for example: R/G/B values, thus signal values of a respective color channel (=color signal value).

Considered from yet another somewhat different point of view, the approach according to the invention can also be described as follows:

In a method for generating an overlay image, which can be designed in particular as described above and/or according to one or more of the features disclosed herein, it is provided that the overlay image jointly visualizes image signal components of a white light image and image signal components of a spectral image, in particular of a fluorescence image. Furthermore, it can be provided to solve the stated problem that to generate the overlay image, a respective ratio is selected depending on location, in particular pixel by pixel, using which local color channel values (R/G/B) of the white light image and associated local signal values (R/G/B; GW) of the spectral image are offset with one another. To achieve the object, it can furthermore be provided that the respective ratio is calculated using an overlay function OF(I)=f(I(x,y)), which specifies, in direct or indirect dependence on a respective local intensity value I(x,y) of the original spectral image, by which absolute value the respective local color channel value of the white light image is increased/amplified/accentuated or is reduced/attenuated/lowered upon said offset to generate the overlay image. This overlay function can thus be understood as an “overlay function” which specifies the respective local weighting using which the two images are to be superpositioned with one another in different image areas of the overlay image.

The overlay function OF(I) can thus define in particular which color channel values (for example, R/G/B) of the white light image are attenuated as complementary color channel values in relation to a specific local false color FF(x,y) to be displayed in the overlay image and/or which of these color channel values of the white light image are to be amplified or at least not attenuated as non-complementary color channel values. Using this approach, the local false color FF(x,y) to be displayed can also be displayed in true color in the overlay image, thus without significant color shift. A color shift would be classified as significant here in any case if it resulted in a significant error with respect to an inference about the intensity I(x,y) of the spectral image underlying the false color.

If the overlay function OF(I) is to generate, for example, an RGB representation of the overlay image, it can be specified as a vector made up of three respective correction functions OF(I)=(ΔR(I), ΔG(I), ΔB(I)). In this case, for example, ΔG(I) is the correction function which specifies by which value the color value G of the green color channel of the overlay image is increased or reduced, as a function of the intensity I(x,y) of the spectral image. Technically equivalently thereto, the overlay function OF(I) can also be formed by means of respective correction functions (each per color channel, thus, for example, for red: ΔR=f(R_{FF},G_{FF},B_{FF})) which do not take into consideration the intensity I(x,y) of the spectral image, but rather R_{FF}/G_{FF}/B_{FF} values of a false color representation FF(x,y) of the spectral image, wherein these false colors FF(x,y)=f(I(x,y)) then depend on the intensity I(x,y) of the spectral image, thus, for example:

ΔR=f(R_{FF}(I(x,y)),G_{FF}(I(x,y)),B_{FF}(I(x,y)))

using, for example, G_{FF}(I(x,y)) the false color value of the green color channel of the false color spectral image (FCI), which is calculated depending on location in each case from the local intensity I(x,y) of the spectral image.

The above-explained three methods, which can also be used in combination to achieve the object, can also be refined as follows:

It can be provided, for example, that upon the calculation of the overlay image from the original spectral image, a false color representation FF(x,y) of the spectral image in the form of a false color spectral image is generated by means of a mapping function MF(I). This step can in particular be an intermediate step in the calculation of the overlay image. Furthermore, said false color representation or the false color spectral image can also only be partially visualized in the overlay image. This is because, for example, in image areas in which the original spectral image does not display any appreciable intensity, the false color representation can also be completely hidden under certain circumstances, so that in these image areas of the overlay image, only the original white light image is visualized, then under certain circumstances without any change. Upon use of such a mapping function MF(I), it is preferred if this assigns a specific local false color FF(x,y) to a respective local intensity value I(x,y) of the original spectral image. A mathematical mapping is thus described between an area locally captured in each case in the spectral image of possible intensity values (for example, at an 8-bit resolution in a value range from 0 . . . 255) and a false color space, in which the respective false color is coded, for example the HSV color space.

The mapping function MF(I) can map here in a false color partial space (for example within the mentioned HSV color space). This false color partial space, which thus represents a subset of an available color space, can in particular comprise only a single false color value H, but, for example, different color saturation values S and/or different color brightness values H. If the intensity of the spectral image is to be represented, for example, by means of the false color green, it is sufficient to change the color saturation value S of this false color in the false color spectral image, in order to thus visualize the distribution of the intensity in the original spectral image.

However, the false color partial space can also comprise multiple different false color values H. For example, false colors from dark blue via light blue, turquoise, green, to yellow can be used in order to visualize the intensity of the original spectral image in a “heat map”. In such a case, it is then preferred if these different false color values span a continuous path within the false color partial space. This is because in this case a continuous intensity distribution of the original spectral image can be visualized by a continuous color course within the false color partial space in the overlay image. This is advantageous to be able to infer as accurately as possible the original intensity I(x,y) on the basis of the overlay image.

One preferred embodiment therefore provides designing a visualization system, for example in the form of an endoscope or microscope (which can in particular be designed as described here), so that it is configured for sensorially capturing a white light image (WLI) and a spectral image, thus in particular a fluorescence image, and for visualizing an overlay image. In this case, the overlay image jointly visualizes image signal components of the white light image and image signal components of the spectral image. The visualization is furthermore configured to visualize said overlay image using an overall color space, wherein the white light image is visualized using colors of a VIS color space as a subset of the overall color space and the spectral image is visualized by means of false colors of a remaining residual color space of the overall color space (i.e. the VIS color space and the residual color space add up to form the overall color space used). Furthermore, the false colors of the residual color space are selected unconnected from the colors of the VIS color space; i.e. the false colors are in particular not part of the VIS color space, but rather are located exclusively in the residual color space. The size of the VIS color space can also change in this case depending on the current VIS image and tissue visualized therein (for example if initially no fatty tissue and then yellow fatty tissue is visible, which is to be visualized in the VIS image). It is thus characteristic that the false color scale (or the color bandwidth of the false colors used) never penetrates into the VIS color space (thus is designed disconnected therefrom).

This approach can be understood to mean that a VIS image is reproduced by the visualization system in a colored representation which occupies a specific part of the available color space, thus, for example, the color spectrum from green to red. Accordingly, there is then a residual color space, namely the remaining residue of the overall available color space. The invention has recognized here that it is advantageous for the visualization if the false colors which are used for the visualization of the spectral image/fluorescence image are unconnected from the component of the color space which is used to display the VIS image. This is because it can thus be accurately recognized, for example, where in the scene a fluorescence occurs.

The false color scale can preferably even be designed as complementary to the VIS color space, thus occupy the entire remaining residual color space. This is advantageous because then the false color scale can have a maximum length/color bandwidth, which is in turn advantageous to be able to resolve as many intensity levels of the fluorescence signal as possible as finely as possible by means of different colors. If, for example, only the color space from turquoise to yellow were used, possibly three colors, namely yellow, orange, and green, could be recognized by the user. With the solution proposed here, however, the false color space can extend from dark blue via turquoise, green, orange to yellow, so that five different false colors and therefore five intensity levels can be distinguished on the display screen by the operator.

It can be provided in particular that the spectral image is visualized by means of a false color scale (color map) which extends continuously within the residual color space. The false color scale preferably extends over at least 80% of the remaining residual color space here. This is because intensity differences of the fluorescence signal can thus be visualized by a broad palette of false colors from the residual color space. The false color scale is ideally displayed here to the user together with the VIS image and/or the overlay image, so that this user can easily infer the visualized intensity of the fluorescence signal on the basis of the scale.

The visualization system can furthermore be configured to progressively determine the current VIS color space on the basis of image information of a sensorially captured VIS image (and therefore automatically also the remaining residual color space) and to define the false color scale on the basis of the determined current VIS color space. If, for example, the bandwidth of colors in the current sensorially captured (using the image sensor) VIS color space increases, for example because previously nonvisible yellow fatty tissue now comes into view, the visualization system can accordingly shrink the color bandwidth of the residual space accordingly, thus, for example, transfer yellow as a false color from the residual color space into the VIS color space. Such a procedure always enables an optimum false color representation using the greatest possible color bandwidth. According to this approach, the bandwidth of the residual color space used for the false color representation is thus dynamically adapted, depending on which color bandwidth is currently required to represent the VIS signal in the VIS color space.

If, for example, yellow fatty tissue is visualized in the VIS image, it is advantageous if the false color scale no longer extends into the yellow range. It is very particularly advantageous if the visualization system itself continuously/progressively determines the occupied VIS color space from a current VIS image (which is sensorially captured using the image sensor of the system) and always currently determines the available residual color space therefrom. Subsequently, the visualization system can automatically adapt the false color scale such that the false color scale always lies within the instantaneously determined residual color space. Different intensity levels or different local signal values of the spectral image can thus be visualized by means of the false color scale to the operator in the finest possible color graduation.

The above-mentioned mapping function assigns a specific false color to an intensity as explained. The mapping function can be designed here so that it performs this assignment/mapping for all pixels of the false color representation FF(x,y), which is calculated from the intensity distribution I(x,y) of the spectral image with the aid of the mapping function: MF(x,y)=f(I(x,y)).

If the mapping function is to generate, for example, an RGB false color representation, it can be described as a vector made up of three individual mapping functions for the respective color channel value (R/G/B), thus, for example: MF(I)=(R(I),G(I),B(I)), wherein, for example, R(I) represents the mapping function for the red color channel, which assigns a specific color value of the red color channel R(I) to each intensity value I(x,y).

The above-described first alternative using only one single false color value can be achieved, for example, by means of a mapping function which is based on a brightness scale and/or a saturation scale of a specific false color, for example green. The second alternative (thus upon the use of different false color values), in contrast, can be implemented by means of a mapping function, for example, which is based on a preferably continuous false color scale. This false color scale can thus comprise a continuous spectrum of different color values. With the second alternative, the false color spectral image can therefore be present, for example, in the form of a colored “heat map”; with the first alternative as a brightness image in a single green false color.

The false color partial space (residual color space) can be selected in a specific manner, in particular as a function of the color partial space (VIS color space) which is occupied by the white light image (WLI). This is because in general the false color partial space will only cover a part of an overall color space available for representing the overlay image; the rest of the color space can then be occupied by the WLI image, without a color overlap occurring, which is advantageous for a reliable color interpretation of the overlay image. This is explained in more detail hereinafter.

At least “partial” visualization can be understood here to mean that only specific details of the false color spectral image can also be visualized in the overlay image or that, for example, specific areas of the false color spectral image can be hidden in the overlay image.

The false color spectral image or the false color representation FF(x,y) can preferably visualize the false colors blue, turquoise, green, and yellow, preferably in this order. In particular in medical applications, a particularly advantageous color visualization, because it can be resolved precisely, of different intensity levels of the original spectral image can thus be achieved.

The mapping function MF(x,y) can thus in particular describe a continuous false color course in the false color partial space, preferably from blue to turquoise to green to yellow. It is particularly preferred here if high intensity values of the spectral image are assigned to a yellow false color and low intensity values of the spectral image are assigned to a blue false color. This is because this corresponds to a color value intensity inference which is intuitively correctly interpreted by humans. The false color spectral image can also comprise black as a false color here, namely in particular in those image areas in which the intensity values of the spectral image lie below an intensity threshold.

The false color spectral image or the false color representation FF(x,y) can also, for example, only visualize the false color green and possibly also the false color black. This is because a complex intensity distribution of the original spectral image can therefore also be visualized in the overlay image. The mapping function MF(x, y) can accordingly describe a continuous brightness and/or saturation course in the false color partial space for at least one false color, in particular for a false color course from black to green. It is preferred in this case if high intensity values of the spectral image are assigned to a green false color and low intensity values of the spectral image are assigned to a black false color.

In the method according to the invention, it can be provided that local color channel values of the white light image and respective false color signal values of the false color spectral image are offset with one another in respective different local weighting, namely depending on the local original intensity value of the spectral image. This approach is in particular applicable to the above-mentioned location-dependent offsetting.

As already mentioned, a respected local false color of the false color spectral image (thus a false color which is to be used locally to visualize the intensity of the original spectral image in the overlay image) can define a respective local complementary color KF(x,y). In this case, it can be provided that the mentioned at least one color channel value of the white light image which corresponds to this complementary color KF(x,y) is reduced in each case in a location-dependent manner, in particular pixel by pixel. Using this approach, a color shift of the respective local false color in the resulting overlay image, which could arise due to the offsetting of the white light image with the spectral image, can be at least limited or prevented entirely.

In all above-mentioned approaches, it is technically equivalent according to the invention if the described reduction of the complementary color channel value and/or the respective offsetting and/or the described ratio is in each case not performed in direct dependence on the intensity value I(x,y), but rather only in dependence on a false color FF(x,y) to be displayed locally. Because the false color FF(x,y) to be displayed—more precisely its color value H and/or its saturation S and/or its brightness V—is a function of the original local intensity I(x,y) of the spectral image (because the false color is supposed to visualize the intensity distribution of the original spectral image/fluorescence image, which is monochromatic under certain circumstances), the type of the overlay is also performed in this approach in a location-resolved manner in at least indirect dependence on the respective intensity value I(x,y). This is also true if the false color representation FF(x,y) is a nonlinear function of I(x,y), because then this is still dependent on I(x,y).

Of course, methods according to the invention can also only be applied to individual image areas. That is to say, the entire part of an already sensorially captured spectral image does not necessarily have to be taken into consideration, but rather said overlay can be restricted, for example, only to those image areas in which a significant intensity, which is therefore to be represented, was sensorially captured in the original spectral image at all.

The overlay image can, as was already indicated, be calculated on the basis of an overlay function OF(x,y)—which can be understood as an “overlay function”. This overlay function can in particular be predefined here and/or can be adaptable by a user (for example, via an operating interface of the image recording device used). The overlay function now specifies, in direct or at least in indirect dependence on a respective local intensity value I(x,y) of the original spectral image by which absolute value the respective local color channel value of the white light image is to be increased/amplified/accentuated or reduced/attenuated/lowered. It is preferred in this case if a local color channel value of the white light image is increased/amplified/accentuated if this local color channel value corresponds to an associated local false color which is to be implemented as an image signal component of the spectral image at this point (x, y) in the overlay image. Furthermore, it can be advantageous if a local color channel value of the white light image is reduced/attenuated/lowered if it is complementary to an associated local false color, which is to be visualized as an image signal component of the spectral image at this point (x,y) in the overlay image.

As was already mentioned at the outset, the white light image and the spectral image/the fluorescence image can both be sensorially captured using a single image recording device, wherein this device can in particular be designed in the form of an endoscope, an exoscope or a microscope and will be explained in more detail hereinafter. However, in this case this device can comprise multiple image sensors.

This is because a variety of approaches are conceivable in the sensorial separate acquisition of the two images: For example, the white light image and the spectral image/the fluorescence image
i) can be sensorially captured spatially partitioned/separate from one another, in particular by means of at least two separate image sensors and/or by means of different color filters on the pixel of an image sensor, in particular an RGBX sensor or a hyperspectral sensor; or
ii) the sensorially separate capture can take place chronologically separate from one another, in particular by means of a chronologically varying illumination. Such a chronologically separate capture can also take place on the basis of a chronologically alternating capture of the two images using one image sensor (under certain circumstances a single image sensor).
iii) The separate sensorial capture of the two images can also be achieved solely by intelligent signal processing, in particular wherein both images can be sensorially captured in this case simultaneously and/or by only one single image sensor.
iv) All of these approaches for the separation of a spectral image/fluorescence image from a white light image are previously known from the prior art in broad strokes; however, they can advantageously be used in the approach according to the invention for generating high-quality overlay images.
v) As mentioned, only components of the spectral image, thus specific image details of the spectral image, can also be visualized in the overlay image in a false color representation.
vi) In contrast, the respective components of the white light image can be visualized in the overlay image as a colored white light background image, preferably in true colors, or as a monochromatic grayscale background image. The advantage of the invention, namely that no additional clipping is generated, is also retained with a grayscale image. “Clipped” VIS/WLI image components are also still colored.

The white light image can accordingly comprise pieces of color information from at least two different color channels when it is visualized in color in the overlay image. However, it can also be visualized in the form of a grayscale image.

In contrast, the original spectral image can visualize sensorially captured (using an image sensor) intensity values of a spectral light signal, in particular a fluorescence signal. If the invention is used in a minimal solution, the white light image does not necessarily have to be visualized in color in the overlay image and moreover the spectral image can only be represented, for example, by means of a single false color in the visualization image.

A particularly preferred embodiment of the method provides that in the calculation of the overlay image, it is checked in a location-resolved manner, thus in particular pixel by pixel, in each case whether a value range which is available for the overlay image and/or is displayable at most in the overlay image was exceeded by the overlay of the image signal components of the white light image with the image signal components of the spectral image. If this should be the case, the image signal components of the white light image, in particular the mentioned at least one complementary color channel value, can then be reduced enough that the value range is locally observed. Using this approach, it is avoidable in particular that additional clipping arises in the overlay image, as was described at the outset and is often observed in the prior art.

It is to be mentioned at this point that original clipping image areas of the white light image, which already had/have exceeding of the displayable value range (in particular in the form of white image spots), can certainly still be displayed in the overlay image in this case. This applies in particular to image areas in which the original spectral image has a negligible intensity and then accordingly is shown little to not at all. These original clipping image areas can be visualized in this case under certain circumstances in a correct false color in the overlay image, namely provided that the spectral image has a significant intensity corresponding to the respective original clipping image area, so that therefore the false color is then to be visualized accordingly in this image area.

In simple words, this approach avoids additional “white spots” arising in the overlay image in those image areas in which a relevant intensity I(x,y) of the spectral image is to be visualized by means of a false color. However, the false color can only be correctly visualized if not all color channels used for visualizing the overlay image (locally) have a maximum displayable signal value (which would correspond to the color white in the overlay image). Using this approach, an original clipping, which already existed in the recorded white light image, because individual pixels of the image sensor used displayed a signal full scale, can be preserved in the overlay image. However, the method according to the invention ensures that no significant “color drift” in relation to the image signal component of the spectral image visualized by means of false color arises there in the overlay image. At the same time, additional clipping, which could first arise due to the overlay of the two images and could therefore distort the false color representation in the overlay image, can likewise be avoided.

A further embodiment of the method provides that in the calculation of the overlay image, the different color channel values of the white light image are each increased and/or reduced in a location-resolved manner, in particular pixel by pixel, in direct or in indirect dependence on the local intensity value of the spectral image so that a local overall brightness is retained at least approximately, thus in particular with a relative brightness loss of less than 25%, preferably of less than 10%. The local overall brightness can result in this case in particular from a sum of the color channel values of all color channels of the white light image. However, this does not necessarily have to be the case. Due to this approach, it is possible for no significant image brightness of the white light image to be lost in the overlay image and/or for a brightness contrast of the white light image to be substantially retained locally in each case in spite of the overlay in the overlay image.

If the white light image is provided, for example, as an RGB image having respective pixels, which each have an R, G and B color channel value, the above condition can be observed if it is ensured that even after the respective adaptation of these color channel values of the white light image in the context of the calculation of the overlay image, the sum of these three signal values R/G/B changes by less than 20%, preferably by less than 10%. However, it is also to be taken into consideration in this case that the image brightness, depending on the image format, does not necessarily have to result as a simple addition of color channel values, but rather that a more complex relationship can also exist between these variables, which can then be taken into consideration accordingly, however.

A further variant of the method provides that a local intensity threshold value I₀ is defined for the spectral image and the reduction according to the invention of at least one color channel value of the white light image is only performed locally if the intensity threshold value I₀ in the spectral image is exceeded at this point (x,y), thus if the following applies: I(x,y)>I₀. The intensity threshold value I₀ is to be selected as positive in this case. In this case, the image areas of the white light image in which the spectral image only displays intensity values below the threshold I₀ can be overlaid unchanged with respect to the local color values with the spectral image. The color authenticity of the WLI background in the overlay image can thus be retained with respect to the spectral image of less relevant image areas. Said color channel value which is to be reduced can be, for example, the mentioned complementary color value.

In other words, it can thus be provided that no reduction of the at least one color channel value (for example, B value) of the white light image is performed if the local intensity value is I(x,y)=0 or <I₀.

As mentioned, an image recording device is also proposed to achieve the object, which can be designed in particular in the form of a medical visualization system and/or can comprise an endoscope, an exoscope or a microscope. This device, which was already described at the outset, furthermore comprises an image signal processing unit to achieve the object, which is configured to implement a method as was described above and/or according to one or more of the features described herein. In this case, the image signal processing unit calculates the overlay image from the white light image and the spectral image/fluorescence image, in particular in consideration of an already previously calculated false color representation of the spectral image/a false color spectral image.

The image recording device can also (in a way known per se) comprise an excitation light source for generating excitation light. A spontaneous emission and therefore fluorescent light can be generated using the excitation light, which is then sensorially captured by the at least one image sensor upon the recording of the fluorescence image.

In particular, the image recording device can comprise, for example, two image sensors, such as a color image sensor for sensorially capturing the white light image and a second, in particular monochromatic image sensor which is configured for the spatially separate capturing of the spectral image/the fluorescence image.

The image recording device can furthermore be designed and/or configured analogously as was described above with reference to alternatives i) to iii) (including one or more of the features described herein).

### BRIEF DESCRIPTION OF THE DRAWINGS

The invention will now be described in more detail on the basis of exemplary embodiments, but is not restricted to these exemplary embodiments. Further designs of the invention can be obtained from the following description of a preferred exemplary embodiment in conjunction with the general description, the claims, and the drawings. In the following description of various preferred embodiments of the invention, elements corresponding in their function receive corresponding reference numerals, even with differing design or shaping.

In the figures:

FIG. 1 shows an approach from the prior art for the spatially separate capture of a white light image and a fluorescence image,

FIG. 2 shows a further approach previously known from the prior art for the chronologically separate capture of a white light image and a fluorescence image,

FIG. 3 shows a concept previously known from the prior art, so-called alpha blending, for overlaying a spectral image with a white light image,

FIG. 4 shows a possible implementation of a method according to the invention on the signal processing level,

FIG. 5 illustrates previously known problems which can arise upon overlaying a fluorescence image with a white light image,

FIG. 6 illustrates the application of a method according to the invention to obtain a high-quality overlay image,

FIG. 7 illustrates a mapping function, using which intensity values of a spectral image can be mapped in a false color space,

FIG. 8 illustrates an overlay function, using which it can be defined how individual color channel values of the white light image are to be adapted upon the overlay with the spectral image,

FIG. 9 illustrates a further overlay function for the case that the spectral image is to be illustrated using multiple different false colors,

FIG. 10 illustrates the application of the method according to the invention to the overlay of a spectral image, which is only visualized using a single green false color, with a white light image,

FIG. 11 illustrates the HSV color space,

FIG. 12 illustrates a further view of the HSV color space,

FIG. 13 illustrates, on the basis of a schematic example of a spectral image which shows an intensity distribution, how different image areas of the spectral image can be adapted according to the invention (for each color channel individually),

FIG. 14 illustrates a method according to the invention on the image signal processing level for the case of a false color spectral image which is only visualized using a single green false color, and finally

FIG. 15 shows the application of a method according to the invention on the signal processing level for the case of a false color spectral image which is to be illustrated as an RGB image by means of multiple different false colors in the overlay image.

### DETAILED DESCRIPTION

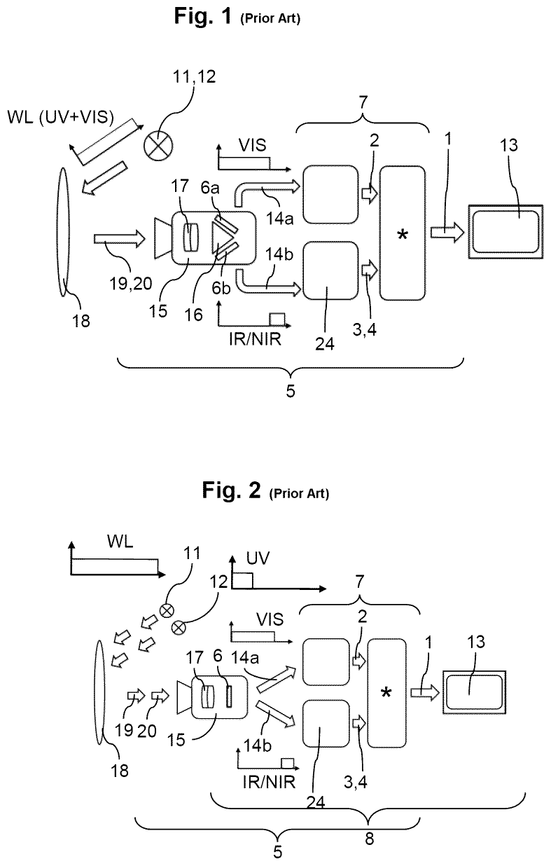

FIG. 1 shows an image recording device 5, which comprises a video camera 15 as part of an endoscope having an imaging optical unit 17, which guides light emitted by an object 18 onto a beam splitter 16. The observed scene is illuminated in this case using broadband white light illumination having wavelengths in the UV range and in the visible range. The object 18 also comprises fluorophores, which are excited by the UV wavelengths to a spontaneous emission in the infrared wavelength range (IR). Of course, fluorophores can also be used which are excitable using wavelengths in the NIR range.

The beam splitter 16 guides the IR wavelengths, thus the fluorescent light, onto a monochromatic image sensor 6b, while the visible wavelengths reach a typical color image sensor 6a. Using the image recording device 5, a white light image 2 can thus be sensorially captured using the image sensor 6a and simultaneously, but spatially separate therefrom, a spectral image 3 in the form of a fluorescence image 4 can be sensorially captured by means of the second image sensor 6b. The image recording device 5 furthermore comprises an image signal processing unit 7, which can consist of a processor and multiple electronic components and is configured to calculate a digital overlay image 1 from the recorded white light image 2 and the recorded spectral image 3. This overlay image 1 can then be displayed on the display unit 13.

The image recording device 5 according to FIG. 1, which is previously known from the prior art, can be designed according to the invention if, as the star symbol in FIG. 1 indicates, the image signal processing unit 7 is configured to implement a method according to the invention.

This also applies to the image recording device 5 in FIG. 2, which is also previously known per se from the prior art and which only differs from that of FIG. 1 in that in FIG. 2 only a single image sensor 6 is used, which captures the white light image 2 and the fluorescence image 4 chronologically separately from one another, however. Specifically, for this purpose alternating illumination made up of illumination light of an illumination light source 11 in the visible range and UV excitation light of an excitation light source 12 is used, wherein these two light sources 11, 12 each illuminate the object 18 alternately in time. Accordingly, illumination light 19 and also fluorescent light 20 thus each alternately reach the imaging optical unit 17 of the image recording device 5.

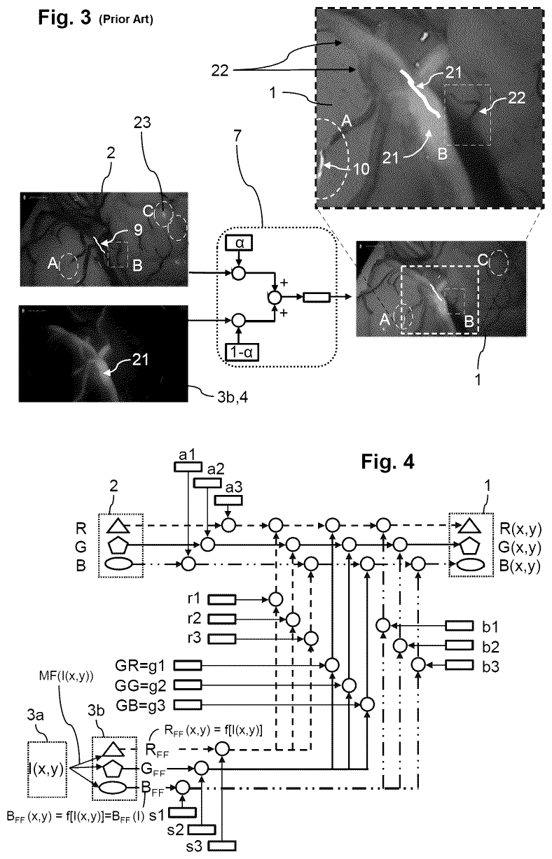

FIG. 3 shows a first approach previously known from the prior art, so-called alpha blending, using which a white light image 2 and a spectral image 3, for example in the form of a false color spectral image 3b, can be overlaid by weighted addition on the signal processing level to form an overlay image 1. For this purpose, the white light image 2 is weighted using a factor α₁<1, while the spectral image 3b is globally weighted using a complementary weighting factor α₂=1−α₁. This approach can in principle avoid additional clipping arising in the overlay image 1; however, the disadvantage of this approach is above all that image brightness is lost in relation to the components of the white light image, as can be seen from the comparison of the detail in the upper right corner of FIG. 3 with the original white light image 2.

In the white light image 2 of FIG. 3, original clipping 9 can also be seen, thus image areas which are shown white, because all three color channels RGB of the white light image 2 already display a full scale there. As can be seen on the basis of detail A, however, with unsuitable selection of the weighting factor α₁, additional clipping 10 can also occur here, thus white image areas which first arise due to the overlay of the two images 2, 3. In detail B, in contrast, a reduced image brightness 22 can be seen as a result of the application of the alpha blending. Due to the globally reduced image brightness of the white light image 2, it can moreover be seen in detail C that an original optical reflection 23, which could still be seen in the original white light image 2, is no longer visible in the overlay image 1. The result is therefore a representation in the overlay image 1 which supplies a worsened spatial impression of the observed scene in comparison to the original white light image 2.

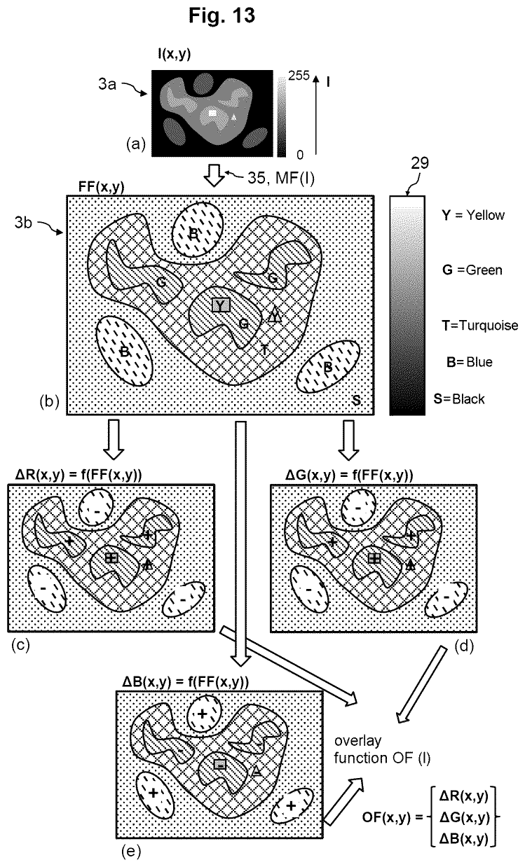

In order to understand the approach according to the invention for generating a high-quality overlay image 1, first FIG. 13 is helpful: At the very top, this shows a schematic illustration of an intensity distribution I(x,y) of a spectral image 3a. As can be seen on the basis of the scale, the intensity of a spectrally narrowly bounded light, for example fluorescence light, having a resolution of 8-bits, thus in a value range of 0 . . . 255 is captured/visualized in a location-resolved manner in the spectral image 3.

By means of a mapping function MF (I), a false color representation FF(x,y) of the spectral image 3a can be generated from the original spectral image 3a in the form of a false color spectral image 3b. As can be seen in FIG. 13, different intensity levels are visualized here in five different false colors in the false color spectral image 3b, namely from black, via blue, turquoise, green, to yellow. The yellow image areas Y in the false color spectral image 3b therefore correspond to those image areas in the original spectral image 3a having the highest intensity.

In the false color spectral image 3b, there are thus different local false colors FF(x,y), for example the blue false color B and the yellow false color Y. If the white light image 2 is recorded, for example, as an RGB image having three color channels R/G/B, a respective complementary color channel can be assigned to each of the local false colors of the false color spectral image 3b. For example, the blue color channel B of the white light image is complementary to the yellow false color Y. With respect to the corresponding complementary color channel values B of the white light image 2, which are complementary to the yellow local false color Y, the method according to the invention now provides that this color channel value B is reduced locally and selectively in relation to the two remaining local color channel values R and G of the white light image 2. However, this reduction does not take place globally as with alpha blending, but rather in indirect dependence on the associated local intensity value I(x,y) of the spectral image 3a: For example, for the square image area in the center of the spectral image 3a, which has a high local intensity I and which is visualized in the false color spectral image 3b using the yellow false color Y, it is advantageous if in the corresponding image area of the white light image 2, the local color channel value B there is deliberately reduced. This can be seen from the “minus” sign in the diagram (e), which illustrates a component/correction function ΔB(x,y) of an overlay function OF(I), with the aid of which the white light image 2 and the spectral image 3 are deliberately overlaid. This is because in the schematic illustration (e), it can be seen that the complementary color channel value B in the central square image area, which corresponds to the central area of the original spectral image 3 illustrated in the false color Y, is deliberately reduced.

A view of diagrams (c) and (d) of FIG. 13 shows here that the remaining color channel values R and G of the white light image 2 in the central square image area, which is visualized in the false color spectral image 3b using the yellow false color Y, are even increased. This is because the colors red and green are simply not complementary to the false color Y to be visualized at this point (x, y).

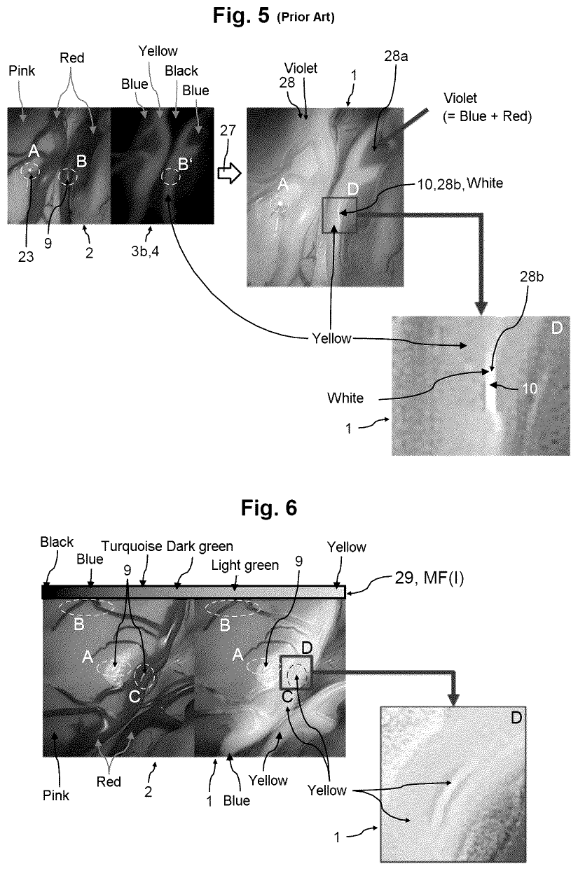

FIG. 5 shows a further example from the prior art of an overlay of a white light image 2 with a spectral image 3 in the form of a fluorescence image 4, which is to be visualized by means of a false color representation as a false color spectral image 3b. The image 3b comprises the false colors black, blue, and yellow here. In this case, the black image areas correspond to regions of low intensity, the blue to moderate intensity, and the yellow to high intensity of the fluorescent light. With a superposition 27 of the two images 2, 3b typical in the prior art, it can occur that in image areas (see, for example, detail B), in which a (here: yellow) false color is to be visualized in the overlay image 1, additional clipping 10 arises, which results in that these image areas are no longer visualized in the correct false color, but rather in white, as can be seen in detail D of the overlay image 1. At this point, a color shift 28b has thus occurred in relation to the yellow false color to be represented at this point.

In addition, however, a further color shift 28a can also be seen in the overlay image 1 of FIG. 5 in an image area in which actually a blue false color is to be visualized. However, the image area there is colored red in the associated white light image 2. Therefore, upon the addition of the blue false color and the red color from the white light image 2, a violet color arises, which is not contained at all in the false color scale used from black via blue to yellow, however. Accordingly, an operator would have difficulties here in assigning an intensity of the fluorescent light on the basis of the false color scale to this image area of the overlay image 1.

FIG. 6 now illustrates how this problem of the color shift of a false color can be avoided using the approach according to the invention: In the left image, a white light image 2 can be seen, which shows a tissue surface having blood vessels which are visualized in red. The white light image 2 thus uses true colors and gives the operator a realistic impression of the observed operation scene. In addition, a false color scale can be seen as a color bar, which extends continuously from black via blue, turquoise, dark green, light green, to yellow and which can be used (comparably to the false color spectral image 3b of FIG. 5) to visualize the intensity of a spectral image 3, in particular a fluorescence image 4. The overlay image 1 produced with the aid of the method according to the invention, which can be seen in the right part of FIG. 6, now, on the one hand, reproduces the original white light image 2 as a colored background image, but at the same time also overlays thereon a false color representation of a fluorescent light signal according to the original spectral image 3. In contrast to the example of FIG. 5, no relevant color shift 28 now occurs, but rather, as detail D shows, the image areas having high fluorescence signal intensity are visualized in the correct yellow false color. This is achieved in that in these image areas the blue color channel value B of the left white light image 2 is deliberately reduced. At the same time, the non-complementary red and green color channel values R and G are increased somewhat in these image areas, so that in spite of reduction of the blue color channel value, the brightness of the pixel in the white light image 2 is substantially retained. As a result, in particular the local brightness course and therefore the contrast of the white light image 2 can be maintained in the overlay image 1. In addition, in contrast to the alpha blending according to FIG. 3, no global brightness loss is to be observed in the overlay image 1.

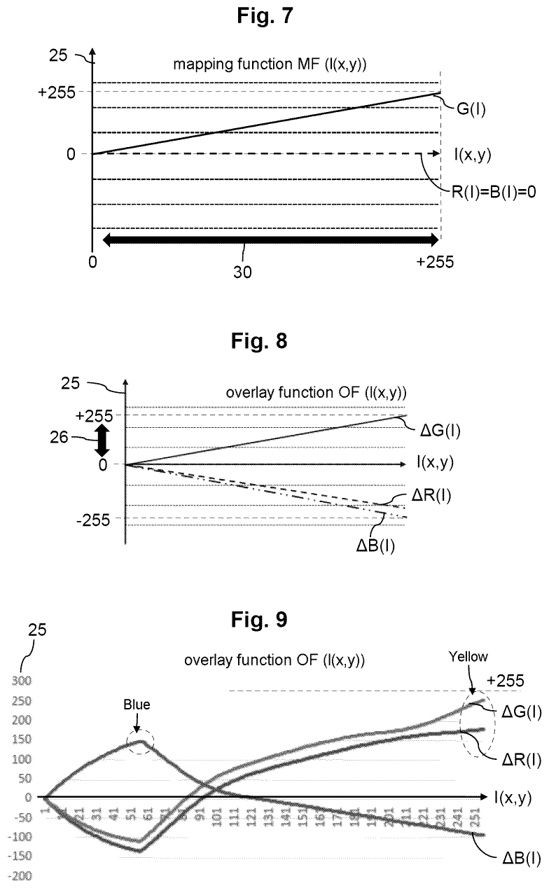

FIG. 7 shows an example of a possible mapping function MF(I), using which different intensity values I(x,y) of an original spectral image 3 can be visualized by means of a green false color G. The mapping function thus assigns each intensity value on the value scale from 0.255 an associated color channel value G(I).

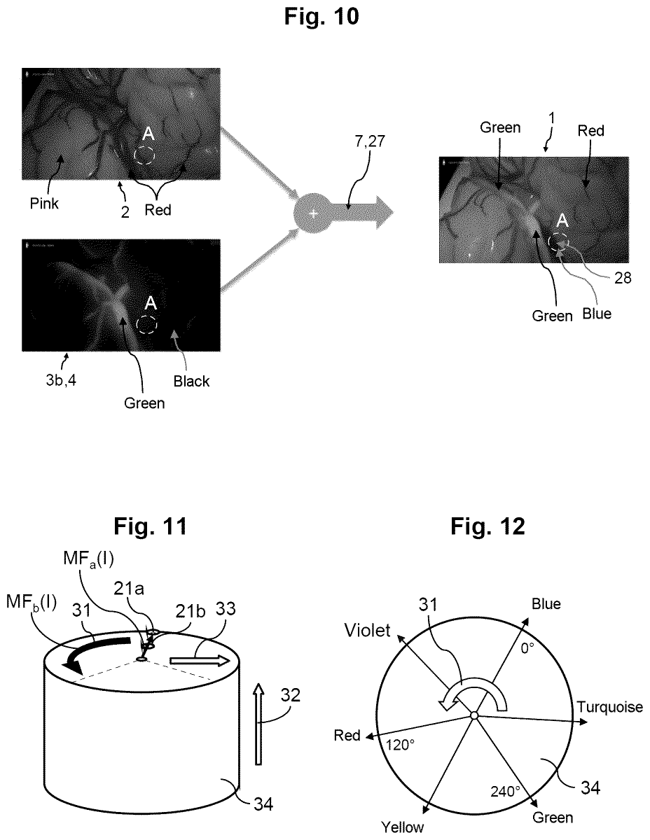

FIG. 10 illustrates how a false color spectral image 3b can be obtained in this manner, in that the respective original intensity I(x,y) of the original spectral image 3 is visualized by means of only a single green false color. In this example, it can be seen that if the method according to the invention is applied in the image areas in which a significant intensity exists in the spectral image 3, no significant color shift is to be observed in the overlay image 1. As detail A shows, however, it can nonetheless occur that in other image areas a certain color shift of the image signal components of the original white light image 2 is to be observed. However, this is less critical for the application if the operator can still recognize a valid false color representation of the spectral image 3 in the overlay image 1.

FIG. 11 illustrates for this purpose a possible color space, the HSV color space, in which the false color representation can be coded. In the example of FIG. 10, for example, it can be imagined that the single green false color is maintained with respect to its color value H, but that either the color brightness 33 (radial axis) and/or the color saturation S 32 (vertical axis) is changed in each case in order to be able to visualize different intensity levels using the green false color. As the thin black arrow in FIG. 11 indicates with respect to the mapping function MFₐ(I), in the false color representation of FIG. 10, the H value of the green false color was kept constant and only the color brightness 33 was varied (in the radial direction in the color space).

In the example of FIG. 6, in contrast, it is the case that different false colors from black to yellow are used to visualize the spectral image 3. Looking at FIG. 12, which shows a view from above of the HSV color space, this can be understood to mean that in this approach a continuous path is defined in the color space, wherein different color values H are assigned depending on the intensity value. Accordingly, the mapping function MF(I) can then comprise multiple components, for example, R(I), B(I), and G(I). In the example of FIG. 6, the associated mapping function would thus initially increase the blue color channel value B at low intensity values, but in contrast would reduce it again at higher intensity values. Since the color yellow is visualized by red and green color channel values, the mapping function would therefore assign high signal values correspondingly high color channel values in the green and red color channel of the false color spectral image 3b.

In the method according to the invention, the overlay image 1 is preferably calculated by means of an overlay function OF(x,y). This overlay function therefore defines in a location-resolved manner for each pixel of the overlay image 1 by which absolute value the respective local color channel value of the white light image 2 is to be increased or amplified, wherein the overlay function OF(x,y) at least indirectly takes into consideration here the respective local intensity value I(x,y) of the original spectral image. In a mapping function, as shown in FIG. 7, which can result in a false color spectral image 3b as illustrated in FIG. 10, the overlay function OF(I(x,y)) can appear, for example, as illustrated in FIG. 8. For lower intensity values, the color channel values R/G/B of the white light image 2 are maintained practically unchanged, because the respective absolute value ΔG/ΔR/ΔB, by which the respective color channel value is increased or decreased, is very small for low intensities I. At a high intensity, for example having a value of 250, in contrast, the absolute value ΔG(I), by which the green color channel value G of the white light image 2 is to be increased, can accordingly result as high, while the two remaining color channel values R and B, which are then complementary to the green false color to be visualized, are simply reduced, which can be tracked on the basis of the large negative values of the factors ΔR and ΔB for high intensity values I in the diagram of FIG. 8.

FIG. 9, in contrast, shows an overlay function for the case of the exemplary application of FIG. 6, in which the spectral image 3 is visualized by means of the continuous false color scale shown from dark blue to yellow. At low intensity values, a blue false color is to be visualized here, in contrast a yellow false color at high intensity values. Accordingly, the overlay function of FIG. 9 shows at low intensity values of I<100 that then the blue color channel value B of the white light image 2 is accordingly increased (ΔB>0). At high intensity values, in contrast, a yellow false color is to be visualized according to the false color scale. Accordingly, the complementary blue color channel value B of the white light image 2 is reduced locally there in each case, namely as a function of the local intensity value I(x,y) of the original spectral image 3, as can be seen in FIG. 9 on the basis of the negative value of the variable ΔB for high intensity values I. The remaining color channel values G and R of the white light image 2, in contrast, are increased at high intensity values; accordingly, the resulting values for ΔG and ΔR in the diagram of FIG. 9 are high.

A possible implementation of a mapping from the original intensity distribution I(x,y) of the original spectral image 3a to a false color representation FF(x,y) in a false color spectral image 3b, as illustrated in FIG. 13, can be understood on the basis of FIG. 4: It can be seen at the left lower image edge how the original spectral image 3a is converted with the aid of the mapping function MF(I(x, y)) into a false color spectral image 3b, visualized by means of three color channel values RGB. The method according to the invention can now be implemented according to FIG. 4 on the signal processing level in that as a function of the respective local color channel value (R_{FF}/G_{FF}/B_{FF}) of the false color spectral image 3b, which are all directly dependent due to the mapping function on the original corresponding local intensity value I(x,y) of the original spectral image 3a, are offset in weighting of different strengths, namely according to the weighting factors (bᵢ, rᵢ, and gᵢ) with the color channel values (R/G/B) of the white light image 2, in order to thus ultimately obtain corresponding color channel values R,G,B of the overlay image 1. This weighting/offsetting is thus executed pixel by pixel at each point x,y of the overlay image, wherein the respective weighting can change at each pixel on the basis of the respective color signal values R_{FF}, G_{FF}, and B_{FF} of the false color spectral image 3b, i.e. in indirect dependence on the original associated intensity value I(x,y) of the original spectral image 3a. The three lower diagrams (c), (d), and (e) of FIG. 13 show such a spatial change of the weighting by way of example for the three color channels R/G/B of the white light image 2.

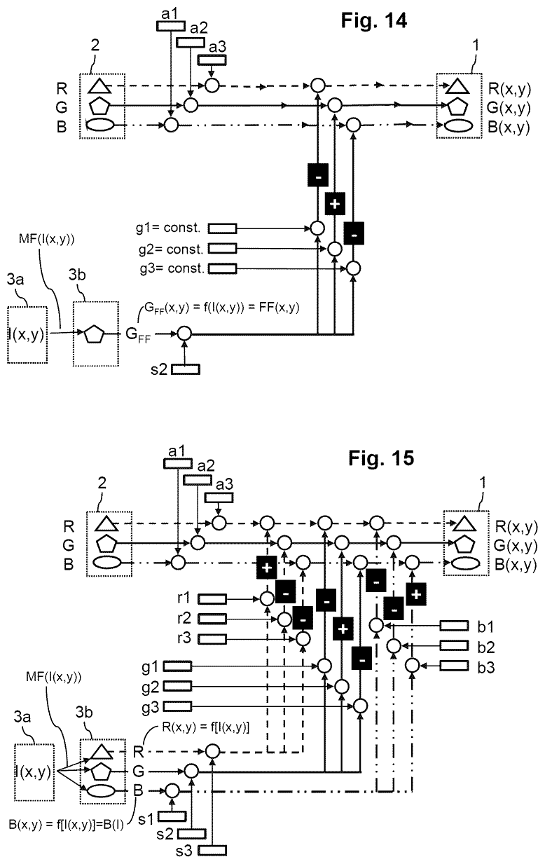

FIG. 14 illustrates the application of the method according to the invention to the case of FIG. 10, thus the visualization of a spectral image 3 using only a single green false color G_{FF}: The false color spectral image 3b only contains a single green color value G_{FF} here, which can be determined locally in each case, for example, on the basis of the mapping function of FIG. 7 in direct dependence on the respective local intensity value I(x,y). The green color channel value G of the white light image 2 is non-complementary for this green false color, while the red color channel R and the blue color channel B of the white light image 2 are simply complementary. The increase or reduction of the respective complementary color component in the RGB color space corresponds here to a saturation change of the overlay color or a color shift in the direction of the saturated overlay color, which is used to represent the fluorescence signal in the form of an image overlay.

It can accordingly be seen in FIG. 14 that with the aid of the weighting factors g1<0, g2>0, and g3<0, the two complementary color channel values R and B of the white light image 2 are reduced in a location-resolved and selective manner in relation to the non-complementary color channel value G (however, only provided a significant color value G_{FF} is to be visualized at this point), while the non-complementary color channel value G of the white light image 2 is accentuated if a green false color is to be visualized in the overlay image 1 at this point. It can thus be ensured by this measure that the green false color is visualized in the overlay image 1 without relevant color shift, and specifically also for pixels of the white light image 2 which actually would illustrate a mixed color complementary thereto (for example, an orange tone or a violet color tone).

As can also be seen in FIG. 14, a respective ratio, using which the respective local color channel value R/G/B of the white light image 2 is to be offset with the associated local signal value G_{FF} of the spectral image 3b, is selected in a location-dependent manner pixel by pixel here to generate the overlay image 1, namely in indirect dependence on the original local intensity value I(x,y) of the respective pixel (x,y) of the original spectral image 3a. The respective weighting can thus be changed between the local color channel values R/G/B of the white light image 2 and the respective local signal value G_{FF} of the spectral image 3b depending on location, depending on the local original intensity value of the spectral image 3a.

FIG. 15, in contrast, shows a possible implementation of the method according to the invention on the signal processing level for the case of FIG. 6, thus the visualization of a spectral image 3 with the aid of a continuous false color scale from dark blue to yellow: The false color spectral image 3b, which can be obtained by means of a mapping function from the original spectral image 3a, now comprises three different color channel values R, G, B, the individual values of which each vary according to local intensity value I (x,y). By means of the weighting factors aᵢ, initially a certain color transformation can be applied to the white light image 2. The same applies for the false color spectral image 3b, which can be color transformed with the aid of the weighting factors si. With the aid of the further weighting factors bᵢ, rᵢ, and gᵢ, the color channel values R/G/B of the false color spectral image 3b can now be offset with the color channel values R/G/B of the white light image 2 in order to thus calculate the overlay image 1.

It can also again be seen here that, for example, when the false color spectral image 3b is locally supposed to visualize a high signal value in a red false color R, this, mediated via the weighting factors r1>0, r2<0 and r3<0, accordingly has an effect on the three color channel values R/G/B of the white light image 2. In this way, the red color channel value R of the white light image 2 is accentuated accordingly, while the remaining color channel values G and B of the white light image 2 are attenuated accordingly. By way of the approach illustrated in FIG. 15, an overlay of the two images 2, 3 can thus be achieved in which the original false color representation of the spectral image 3b can be reproduced nearly unchanged in the overlay image 1, which ensures for the operator observing the overlay image 1 that they can reliably infer, on the basis of the colors of the overlay image 1, the original intensity I(x,y) of the original spectral image 3a.

The entirety of the weighting factors rᵢ, bᵢ, gᵢ illustrated in FIG. 15 in conjunction with the intensity-dependent color channel values R(I)/G(I)/B(I) of the false color spectral image 3b can therefore be understood as an overlay function OF(x,y) in the meaning of the invention, because it is specified by the entirety of the weighting factors by which absolute value the respective local color channel value R(x,y), G(x,y), B(x,y) of the white light image 2 is to be increased or decreased upon the calculation of the overlay image 1, namely depending on the sign of the respective weighting factor and as a function of the color channel values R(I)/G(I)/B(I) of the false color spectral image 3b. In the example of FIG. 15, the weighting factors rᵢ, bᵢ, gᵢ thus each define which color channel values of the white light image 2 are to be attenuated in relation to a specific false color (defined by the three color channel values R, G, B of the false color spectral image 3b) as complementary color channel values and which of these color channel values of the white light image 2 are to be amplified in particular as non-complementary color channel values.

In summary, to generate realistic overlay images 1 which are true-color with respect to at least one false color FF(x,y) used to visualize a spectral image 3a, 3b, a method and an associated image recording device 5 are proposed, which enable undesired color shifts of such a false color in the overlay image 1 to be avoided and a high image brightness of a white light image 2 illustrated as a background image and the original image contrast of the white light image 2 to be substantially maintained in the overlay image 1 in spite of the overlay. For this purpose, it is provided according to the invention that at least one color channel value of the white light image 2, which is complementary to the respective false color to be locally displayed, is deliberately locally reduced in each case, all the more the higher the resulting intensity I(x,y) of the spectral image 3a likewise to be visualized in the overlay image 1 is at this point (x,y) (cf. FIG. 6).

### LIST OF REFERENCE SIGNS

1 overlay image
2 white light image (WLI)
3 spectral image (SI)
4 fluorescence image (FI)
5 image recording device (image acquisition device)
6 image sensor
7 image signal processing unit
8 visualization system
9 original clipping image areas (in 2—“original clipping”)
10 additional clipping image area (in 1—“additional clipping”)
11 illumination light source
12 excitation light source
13 display unit
14 image signals (from 6)
15 video camera
16 beam splitter
17 imaging optical unit
18 object
19 illumination light
20 fluorescent light
21 false color
22 reduced image brightness/loss of image contrast
23 optical reflection (on wet tissue)
24 false color calculation unit
25 color channel value (for example, in 8-bit resolution with value range from 0 to 255, for example of 2/3/1)
26 displayable/usable value range (for 25)
27 superposition/overlay (of 2 and 3)
28 (false) color shift (color drift)
29 false color scale
30 value range for intensity I(x,y) (from 3)
31 color value (hue, H)
32 color saturation (saturation, S)
33 color brightness (value, V)
34 displayable color space
35 false color mapping

1. A method for generating an overlay image (1), wherein the overlay image (1) jointly visualizes image signal components of a white light image (2) (WLI) and image signal components of a spectral image (3a), the method comprising:
visualizing local intensity values I(x,y) of the spectral image (3a) in at least one local false color FF(x,y) in the overlay image (1);
wherein the white light image (2) is visualized by grayscales or by true colors in the overlay image (1), and
to generate the overlay image (1), offsetting local color channel values (R/G/B) of the white light image (2) and associated local signal values (R/G/B or GW) of the spectral image (3a, 3b) with one another;
reducing at least one complementary color channel value (B) of the white light image (2), which is complementary to the at least one local false color FF(xᵢ,yᵢ) locally and selectively in relation to the remaining local color channel values (R, G) of the white light image (2), in direct or at least in indirect dependence on an associated local intensity value I(x,y) of the spectral image (3a); and
at least one of
a) maintaining or increasing the remaining color channel values (R, G) of the white light image (2) are locally and selectively in direct or indirect dependence on the local intensity value I(x,y) of the spectral image (3a),
b) reducing the at least one complementary color channel value (B) of the white light image (2) more strongly depending on location a higher the resulting respective local intensity value I(x,y) of the spectral image (3a), or
c) reducing the at least one complementary color channel value (B) of the white light image (2) by different strengths, at different locations (x,y) of the overlay image (1), depending on the associated local intensity value I(x,y) of the spectral image (3a).

2. A method for generating an overlay image (1), wherein the overlay image (1) jointly visualizes image signal components of a white light image (2) (WLI) and image signal components of a spectral image (3a), the method comprising:
visualizing local intensity values I(x,y) of the spectral image (3a) in at least one local false color FF(x,y) in the overlay image (1);
wherein the white light image (2) is visualized by grayscales or by true colors in the overlay image (1); and
to generate the overlay image (1), offsetting local color channel values (R/G/B) of the white light image (2) and associated local signal values (R/G/B or GW) of the spectral image (3a, 3b) with one another using a respective ratio that is selected depending on location and in direct or indirect dependence on a respective original local intensity value I(x,y) of a respective pixel (x,y) of the spectral image (3a),
so that a respective weighting between the local color channel values (R/G/B) of the white light image (2) and the local signal values of the spectral image (3a, 3b) changes depending on location, depending on the local original intensity value I(x,y) of the spectral image (3a).

3. A method for generating an overlay image (1), wherein the overlay image (1) jointly visualizes image signal components of a white light image (2) (WLI) and image signal components of a spectral image (3a), the method comprising:
visualizing local intensity values I(x,y) of the spectral image (3a) in at least one local false color FF(x,y) in the overlay image (1);
wherein the white light image (2) is visualized by grayscales or by true colors in the overlay image (1), and
to generate the overlay image (1), offsetting local color channel values (R/G/B) of the white light image (2) and associated local signal values (R/G/B or GW) of the spectral image (3a, 3b) with one another using a respective ratio that is selected depending on location;
calculating the respective ratio using an overlay function OF(I)=f(I(x,y)), which specifies, in direct or indirect dependence on a respective local intensity value I(x,y) of the original spectral image (3a), by which absolute value the respective local color channel value of the white light image (2) will be increased/amplified/accentuated or reduced/attenuated/lowered upon the offsetting to generate the overlay image (1);
wherein the overlay function OF(I) defines at least one of a) which of the color channel values (R/G/B) of the white light image (2) are attenuated in relation to a specific local false color FF(xᵢ,yᵢ) to be displayed in the overlay image (1) as complementary color channel values (B), or b) which of the color channel values (R/G/B) of the white light image (2) are amplified as non-complementary color channel values (R,G),
to thus also display the local false color FF(xᵢ,yᵢ) to be displayed with true color/without significant color shift in the overlay image (1).

4. The method as claimed in any one of preceding claim 1, further comprising during the calculation of the overlay image (1), generating a false color representation FF(x,y) of the spectral image (3a) from the original spectral image (3a) by a mapping function MF(I) in a form of a false color spectral image (3b), which is at least partially visualized in the overlay image (1),
wherein at least one of a) the mapping function MF(I) assigns a specific local false color FF(H,S,V) to a respective local intensity value I(x,y) of the original spectral image (3a), or b) the mapping function MF(I) maps into a false color partial space, which
comprises only a single false color value H, or
comprises multiple different false color values H.

5. The method as claimed in claim 4, wherein at least one of a) the false color spectral image/the false color representation FF(x,y) is adapted to visualize/visualizes the false colors blue, turquoise, green, and yellow, b) the mapping function MF(x,y) describes a continuous false color course in the false color partial space from blue to turquoise to green to yellow, c) wherein high intensity values I(x,y) of the spectral image (3) are assigned to a yellow false color and low intensity values I(x,y) of the spectral image (3) are assigned to a blue false color, or d) the false color spectral image FF(x,y) also comprises black as a false color.

6. The method as claimed in claim 1, wherein at least one of a) the false color spectral image/the false color representation FF(x,y) is adapted to visualize/visualizes the false color green, and the false color black, or
b) the mapping function MF(x,y) describes at least one of a continuous brightness course or saturation course in the false color partial space for at least one false color, and high intensity values I(x,y) of the spectral image (3) are assigned to a green false color and low intensity values I(x,y) of the spectral image (3) are assigned to a black false color.

7. The method as claimed in claim 1, wherein the location-dependent offsetting, local color channel values (R, G, B) of the white light image (2) and respective false color signal values (R, G, B) of the false color spectral image (3b) are offset with one another in different local weighting in each case, depending on the local original intensity value I(x,y) of the spectral image (3a).

8. The method as claimed in claim 4, wherein a respective local false color FF(xᵢ,yᵢ) of the false color spectral image (3b) defines a respective complementary color KF(x,y) and wherein at least one color channel value of the white light image (2), which corresponds to the complementary color KF(x,y) is reduced in a location-dependent manner in each case, to thus limit a color shift (28) of the respective local false color FF(xᵢ,yᵢ) in the resulting overlay image (1).

9. The method as claimed in claim 1, wherein the overlay image (1) is calculated on based on an overlay function OF(x,y), which specifies, in direct or at least indirect dependence on a respective local intensity value I(x,y) of the original spectral image (3a), by which absolute value the respective local color channel value (R/G/B) of the white light image (2) is increased/amplified/accentuated or reduced/attenuated/lowered,
Wherein at least one of a) a local color channel value of the white light image (2) is increased/amplified/accentuated if it corresponds to an associated local false color FF(xy) which is supposed to be/is visualized as an image signal component of the spectral image (3a) at this point (x,y) in the overlay image (1), or a local color channel value of the white light image (2) is reduced/attenuated/lowered if it is complementary to an associated local false color FF(xy) which is supposed to be/is visualized as an image signal component of the spectral image (3a) at this point (x,y) in the overlay image (1).

10. The method as claimed in claim 1, wherein the white light image (2) and at least one of the spectral image (3) or a fluorescence image (4) are both sensorially captured using a single image recording device (5).

11. The method as claimed in claim 10, wherein the white light image (2) and the at least one of the spectral image (3) or the fluorescence image (4) i) are sensorially captured spatially separate from one another by at least one of at least two image sensors (6a, 6b) or by different color filters on a pixel level of an image sensor,
ii) are sensorially captured chronologically separate from one another, by at least one of a chronologically varying illumination or the two images (2, 3/4) are captured chronologically alternating using one image sensor (6), or
iii) are only separated from one another by intelligent signal processing, in which both of images (2, 3/4) are sensorially captured at least one of at a same time or by only one single image sensor.

12. The method as claimed in claim 1, further comprising at least one of a) visualizing components of the spectral image (3) in the overlay image (1) in a false color representation FF(x,y), or b) visualizing components of the white light image (3) in the overlay image (1) as a colored white light background image or as a monochromatic grayscale background image.

13. The method as claimed in claim 1, wherein the white light image (2) is visualized as a grayscale image or at least one of a) the white light image (2) comprises color information from at least two different color channels or the original spectral image (3) visualizes sensorially captured intensity values I(x,y) of a spectral light signal.

14. The method as claimed in claim 1, further comprising checking in the calculation of the overlay image (1) in a location-resolved manner, whether by overlaying the image signal components of the white light image (2) with the image signal components of the spectral image (3a), a value range (26) is at least one of available or displayable at most in the overlay image (1) would be exceeded, and wherein, provided this is the case, reducing the image signal components of the white light image (2) enough so that the value range (25) is locally observed, so that additional clipping (10) is avoided in the overlay image (1),
wherein original clipping image areas (9) of the white light image (2), which already have exceeding of the displayable value range are still displayed in the overlay image (1), but in a correct false color, if the spectral image (3) has a significant intensity I(x,y) corresponding to the respective clipping image area (9).

15. The method as claimed in claim 1, wherein in the calculation of the overlay image (1), the different color channel values (R/G/B) of the white light image (2) are each at least one of increased or reduced in a location-resolved manner, in direct or in indirect dependence on the local intensity value I(x,y) of the spectral image (3a) so that a local overall brightness, which is formed by a sum of the color channel values (R/G/B) of all color channels of the white light image (2),
is at least approximately retained, such that at least one of no significant image brightness of the white light image (2) is lost in the overlay image (1) or a brightness contrast of the white light image (2) is substantially maintained locally in each case in spite of the overlay in the overlay image (1).

16. The method as claimed in claim 1, further comprising defining a local intensity threshold value I₀, and a reduction of at least one color channel value (B) of the white light image (2) is only performed locally if the intensity threshold value I₀ in the spectral image (3) is exceeded at this point (x,y), such that: I(xᵢ,yᵢ)>I₀.

17. An image recording device (5), comprising:
a medical visualization system (8), having at least one image sensor (6), which is configured for sensorially capturing a white light image (2) and a spectral image (3);
an image signal processing unit (7), which is configured to generate an overlay image (1) from a white light image (2) recorded using the at least one image sensor (6) and a spectral image (3), recorded using the at least one image sensor (6), and to output a digital overlay image (1), and the image signal processing unit (7) is configured to generate the overlay image (1) according to the method of claim 1.
